(19) United States
(12) Patent Application Publication
(10) Pub. No.: US 2012/0302468 A1
(43) Pub. Date: Nov. 29, 2012

(54) FORMULATIONS AND USES OF DRILLING FLUIDS CONTAINING VISCOSIFIED PHOSPHATE BRINE

(75) Inventors: Olusegun Matthew Falana, San Antonio, TX (US); Burhan (Bruno) Hoxha, Houston, TX (US); Raynard Veldman, Bellaire, TX (US); Edmund Sandoval, San Antonio, TX (US); Thomas P. Wilson, JR., Floresville, TX (US); Frank Zamora, San Antonio, TX (US)

(73) Assignee: CLEARWATER INTERNATIONAL, LLC, Houston, TX (US)

(21) Appl. No.: 13/117,304

(22) Filed: May 27, 2011

(51) Int. Cl. C09K 8/035; C09K 8/60

(52) U.S. Cl. 507/110; 507/120; 507/213; 507/225

(57) ABSTRACT

Viscosified phosphate brine base fluids are disclosed, where the fluids include a hydratable polymer, have a density at or above about 10 lb/gal and a viscosity of at least 5 cP. Method for making and using the viscosified phosphate brine base fluids are also disclosed, including using the fluid in drilling, completing, and/or fracturing of oil and/or gas wells.

### BACKGROUND OF THE INVENTION

1. Field of the Invention

Embodiments of the present invention relate to compositions including a viscosified phosphate brine base fluids for drilling, completing, and/or fracturing of oil and/or gas wells and to method for making and using same.

More particularly, embodiments of the present invention related to compositions including a viscosified phosphate brine base fluids for drilling, completing, and/or fracturing of oil and/or gas wells and to method for making and using same, where the fluids include a hydratable polymer and where the brine has a density at or above about 10 lb/gal, where the brine has a viscosity of at least 5 cP, and a temperature stability up to about 600° F.

2. Description of the Related Art

Historically, phosphate salts are produced by reacting phosphoric or polyphosphoric acid with metal hydroxides. Prior teaching also includes use of ion exchange resin columns (see U.S. Pat. Nos. 4,935,213 and 3,993,466). While direct neutralization produces brines that might be unsuitable in applications where clear fluids are required, the use of ion exchange columns to clarify the brines is unwarranted in many large scale processes and adds to production cost.

To-date, preparations of high density phosphate brines have been difficult and limited to the production of phosphate brines having densities only up to about 10 lb/gal (Specific Gravity of 1.8). Most, phosphate brines are prepared commercially by the treatment of phosphate rock so called “rock salt” (see S. M. Jasinski; “Phosphate Rock”, US Geological Survey Minerals' Yearbook, 2003 and U.S. Pat. No. 3,993,466) or phosphoric acid with alkali metal hydroxides. This process requires ready availability of the afore mentioned materials. However, demand for these reagents for other uses is high. For instance, phosphate salts find applications in pharmaceutical, agricultural and detergent industries. Thus, high demand limits production of high density brines and makes the economics of the neutralization process at best uncertain.

As such, there is need in the art for economical, simple and reproducible method of preparing heavy phosphate brine fluid for use in drilling, completion and fracturing operation in oil and/or gas production from underground formations.

### DEFINITIONS OF THE INVENTION

An under-balanced and/or managed pressure drilling fluid means a drilling fluid having a hydrostatic density (pressure) lower or equal to a formation density (pressure).

An over-balanced drilling fluid means a drilling fluid having a hydrostatic density (pressure) higher or equal to a formation density (pressure).

The term “fracturing” refers to the process and methods of breaking down a geological formation, i.e. the rock formation around a well bore, by pumping fluid at very high pressures, in order to increase production rates from a hydrocarbon reservoir. The fracturing methods of this invention use otherwise conventional techniques known in the art.

The term “proppant” refers to a granular substance suspended in the fracturing fluid during the fracturing operation, which serves to keep the formation from closing back down upon itself once the pressure is released. Proppants envisioned by the present invention include, but are not limited to, conventional proppants familiar to those skilled in the art such as sand, 20-40 mesh sand, resin-coated sand, sintered bauxite, glass beads, and similar materials.

The term “ppg” means pounds per gallon (lb/gal) and is a measure of density.

### SUMMARY OF THE INVENTION

Embodiments of this invention provide a drilling fluid composition including a phosphate brine base fluid and an effective amount of a viscosifying system, where the phosphate brine base fluid has a density at or above about 10 lb/gal and where the viscosifying system includes a hydratable polymer, polysaccharide gum or a mixture thereof.

Embodiments of this invention provide a completion fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide a fracturing fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide a method for drilling, including drilling an oil and/or gas well with a drilling fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide method for completing an oil and/or gas well including completing an oil and/or gas well with a completion fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide a method for fracturing an oil and/or gas well including fracturing a formation with a fracturing fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide a system for drilling an oil and/or gas well includes supply means adapted to supply a drilling fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides.

Embodiments of this invention provide system for completing an oil and/or gas well including supply means adapted to supply a completion fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides to a completion string during well completion operations and where the viscosifying system includes a hydratable polysaccharide or a mixture of hydratable polysaccharides.

Embodiments of this invention provide a method for fracturing an oil and/or gas well including supply means adapted to supply a fracturing fluid composition including a phosphate brine base fluid and an effective amount of a viscosifying system, where the phosphate brine base fluid has a density at or above about 10 lb/gal and where the viscosifying system includes a hydratable polysaccharide or a mixture of hydratable polysaccharides to a fracturing string during formation fracturing.

### DETAILED DESCRIPTION OF THE INVENTION

The inventors have found that heavy phosphate clear brines can be formulated for use in downhole operations including drilling, completion and fracturing of oil and/or gas wells. Heavy phosphate brines have not been widely adopted in oil field industries and other industries because there is a lack of suitable viscosifiers, suspending or low end rheology modifiers. Suitable viscosifying polymers have now been found to sustain viscosity properties up to 600° F. and a viscosity of at least 5 cP. The inventors have found that viscosified brines are also useful for their suspending properties. Surprisingly, the inventors have found that when a hydratable polysaccharide is added to a phosphate brine, a fluid is achieved that is stable and/or non-degrading up to 600° F. To the best of the inventors' knowledge, this is the first time that the rheological properties of a hydratable polysaccharide have been extended to such high temperatures.

The inventors has found that a novel fluid for oil field use including a viscosified phosphate brine including a phosphate brine and a viscosifying system including a hydratable polysaccharide produces stable viscous phosphate brine fluids. The inventors have found that a unique completion fluid can be prepared and used in environmental sensitive areas as well as non calcium carbonate formations, where a non halite fluid is required or desired. The present fluids are the only non-halite fluids thickened phosphate fluids that allow for better and more unique placement of the fluids. In certain embodiments, the brines are stable up to about 500° F. In other embodiments, the brines are stable up to about 450° F. In certain embodiments, the brines have a viscosity between about 5 cP and about 600 cP. In other embodiments, the brines have a viscosity between about 5 cP and about 500 cP. In other embodiments, the brines have a viscosity between about 5 cP and about 400 cP. In other embodiments, the brines have a viscosity between about 5 cP and about 300 cP. In other embodiments, the brines have a viscosity between about 5 cP and about 200 cP. In other embodiments, the brines have a viscosity between about 5 cP and about 100 cP. In other embodiments, the brines have a viscosity between about 10 cP and about 300 cP. In other embodiments, the brines have a viscosity between about 10 cP and about 200 cP. In other embodiments, the brines have a viscosity between about 10 cP and about 100 cP.

Embodiments of the heavy phosphate brines can be generated at high neutralization reaction temperatures by the neutralization of a hydrogen phosphate with a metal containing base can produce phosphate brines with densities of 18 lb/gal (ppg) or greater depending on the hydrogen phosphate and metal containing base used to prepare the brine. For example, the reaction of potassium monophosphate with cesium hydroxide (CsOH) yields a phosphate brine having a density of about 18 ppg.

In certain embodiments, the phosphate brines are produced by either a direct neutralization reaction procedure or “indirect” or displacement reaction procedure to produce homogenous or heterogeneous (mixed) cation brines. The resultant brines are clear, thus making them suitable for wide applications. In certain embodiments, indirect methods are used to preclude reaction run, run away reaction, and other difficulties associated with procedures using a direct neutralization reaction.

The processes of the present invention can be used to prepare heavy brines comprising a mixture of phosphate salts, at high neutralization reaction temperatures with selective use of mono or di-alkali metal hydrogen phosphates. Some mixed cation phosphate compositions are known in the art including ammonium magnesium phosphate (NH₄MgPO₄), sodium aluminum phosphates [NaAl₃H₁₄(PO₄)₈.4H₂O & Na₃Al₂H₁₅(PO₄)₈] (see, e.g., Kirk-Othmer, Encyclopediea of chemical Technology, 3^{rd} edition, vol 17, p 447, 1982), cesium sodium (or potassium) hydrogen phosphates (CsNaHPO₄ or CsKHPO4). However, cesium potassium phosphates have only been prepared on small scale for use as catalysts to effect transformation of organic molecules into lactone (see, e.g., U.S. Pat. No. 5,502,217) or ester (see, e.g. U.S. Pat. No. 6,723,823).

### Methods for Using Heavy Phosphate Brine of this Invention

### Fracturing

The present invention provides a method for fracturing a formation with a fracturing fluid including a heavy phosphate brine of this invention, where the method includes the step of pumping a fracturing fluid including a proppant into a producing formation at a pressure sufficient to fracture the formation and to enhance productivity, where the proppant props open the formation after fracturing.

The present invention provides a method for fracturing a formation with a fracturing fluid including a heavy phosphate brine of this invention, where the method includes the step of pumping a fracturing fluid including a proppant into a producing formation at a pressure sufficient to fracture the formation and to enhance productivity.

The present invention provides a method for fracturing a formation with a fracturing fluid including a heavy phosphate brine of this invention, where the method includes the step of pumping a fracturing fluid into a producing formation at a pressure sufficient to fracture the formation and to enhance productivity. The method can also include the step of pumping a proppant after fracturing so that the particles prop open the fractures formed in the formation during fracturing.

### Drilling

The present invention provides a method for drilling including the step of while drilling, circulating a drilling fluid, to provide bit lubrication, heat removal and cutting removal, where the drilling fluid includes a heavy phosphate brine of this invention. The method can be operated in over-pressure conditions or under-balanced conditions or under managed pressure conditions. The method is especially well tailored to under-balanced or managed pressure conditions.

### Producing

The present invention provides a method for producing including the step of circulating and/or pumping a fluid into a well on production, where the fluid includes a heavy phosphate brine of this invention.

### Suitable Reagents

Suitable phosphate sources include, without limitation, phosphoric acid, polyphosphoric acid, mono alkali metal hydrogen phosphates, di alkali metal hydrogen phosphates, mixed di alkali metal hydrogen phosphates and mixtures or combinations thereof. Further, alkaline earth metal hydrogen phosphates are suitable. Exemplary examples include mono lithium hydrogen phosphate, mono hydrogen phosphate, mono potassium hydrogen phosphate, mono rubidium hydrogen phosphate, mono cesium hydrogen phosphate, di-lithium hydrogen phosphate, di-hydrogen phosphate, di-potassium hydrogen phosphate, di-rubidium hydrogen phosphate, di-cesium hydrogen phosphate, magnesium hydrogen phosphateand mixture or combinations thereof.

Suitable bases include, without limitation, alkali metal hydroxides, alkaline earth metal and mixtures or combinations thereof. Exemplary examples include lithium hydroxide, sodium hydroxide, potassium hydroxide, rubidium hydroxide, cesium hydroxide, magnesium hydroxide and mixtures or combinations thereof.

It should be recognized that if one wants to form a mixed phosphate brine, then one would use a suitable hydrogen phosphate and a suitable base. For example, if one wanted to prepare a potassium-cesium mixed phosphate brine, then one could start with a potassium hydrogen phosphate and cesium hydroxide or cesium hydrogen phosphate and potassium hydroxide. One can also start with cesium, potassium hydrogen phosphate and neutralize with either potassium or cesium hydroxide depending on the brine to be produced. It should also be recognized that the phosphate brines can include more than two metals as counterions by using a mixture of hydrogen phosphates and/or a mixture of bases.

Suitable hydratable polysaccharides for use in the compositions and methods of this invention include, without limitation, xanthan gums, galactomannan gums, glucomannan gums, guars, derived guars, and cellulose derivatives. Exemplary examples include guar gum, guar gum derivatives, locust bean gum, Karaya gum, carboxymethyl cellulose, carboxymethyl hydroxyethyl cellulose, and hydroxyethyl cellulose. In certain embodiments, hydratable polysaccharide include xanthan gums. Other hydratable polysaccharides include, without limitation, guar gums, hydroxypropyl guar, carboxymethyl hydroxypropyl guar, carboxymethyl guar, and carboxymethyl hydroxyethyl cellulose. Suitable hydratable synthetic polymers for use in the compositions and methods of this invention include, without limitation, mono and copolymers such as polyvinyl alcohol, polyacrylamides, poly-2-amino-2-methyl propane sulfonic acid, and various other synthetic polymers and copolymers, other suitable polymers are known to those skilled in the art and mixtures or combinations thereof.

### Drilling and Completion Fluids

The drilling and completion fluids of this invention, while including a heavy phosphate brine as set forth herein can also include other reagents or additives including those set forth below.

### Sulfur Scavenger

Suitable sulfur scavengers for use in this invention include, without limitation, amines, aldehyde-amine adducts, triazines, or the like or mixtures or combinations thereof. Exemplary examples of aldehyde-amine adduct type sulfur scavengers include, without limitation, (1) formaldehyde reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (2) linear or branched alkanal (i.e., RCHO, where R is a linear or branched alkyl group having between about 1 and about 40 carbon atoms or mixtures of carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (3) aranals (R′CHO, where R′ is an aryl group having between about 5 and about 40 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (4) alkaranals (R″CHO, where R″ is an alkylated aryl group having between about 6 and about 60 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (5) aralkanals (R′″CHO, where R′″ is an aryl substituted linear or branched alkyl group having between about 6 and about 60 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines, and (6) mixtures or combinations thereof. It should be recognized that under certain reaction conditions, the reaction mixture may include triazines in minor amount or as substantially the only reaction product (greater than 90 wt. % of the product), while under other conditions the reaction product can be monomeric, oligomeric, polymeric, or mixtures or combinations thereof. Other sulfur scavengers are disclosed in WO04/043038, US2003-0089641, GB2397306, U.S. patent application Ser. Nos. 10/754,487, 10/839,734, and 10/734,600, incorporated herein by reference.

### Shale Inhibitors

Suitable choline salts or 2-hydroxyethyl trimethylammonium salts for use in this invention include, without limitation, choline organic counterion salts, choline inorganic counterion salts, or mixture or combinations thereof. Preferred choline counterion salts of this invention include, without limitation, choline or 2-hydroxyethyl trimethylammonium halide counterion salts, carboxylate counterion salts, nitrogen oxide counterion salts, phosphorus oxide counterion salts, sulfur oxide counterion salts, halogen oxide counterion salts, metal oxide counterion salts, carbon oxide counterion salts, boron oxide counterion salts, perfluoro counterion salts, hydrogen oxide counterion salts or mixtures or combinations thereof. Other examples can be found in U.S. patent application Ser. No. 10/999,796, incorporated herein by reference.

Exemplary examples of choline halide counterion salts including choline fluoride, choline chloride, choline bromide, choline iodide, or mixtures or combinations thereof.

Suitable choline carboxylate counterion salts include, without limitation, choline carboxylate counterion salts where the carboxylate counterion is of the general formula R¹COO⁻, where R¹ is an alkyl group, alkenyl group, alkynyl group, an aryl group, an alkaryl group, an aralkyl group, alkenylaryl group, aralkenyl group, alkynylaryl group, aralkynyl group hetero atom analogs, where the hetero atom is selected from the group consisting of boron, nitrogen, oxygen, fluorine, phosphorus, sulfur, chlorine, bromine, iodine, and mixture or combinations thereof, or mixtures or combinations thereof. A non-exhaustive list of exemplary examples of choline carboxylate counterion salts include choline formate, choline acetate, choline propanate, choline butanate, cholide pentanate, choline hexanate, choline heptanate, choline octanate, choline nonanate, choline decanate, choline undecanate, choline dodecanate, and choline higher linear carboxylate salts, choline benzoate, choline salicylate, other choline aromatic carboxylate counterion salts, choline stearate, choline oleate, other choline fatty acid counterion salts, choline glyolate, choline lactate, choline hydroxyl acetate, choline citrate, other choline hydroxylated carboxylates counterion salts, choline aconitate, choline cyanurate, choline oxalate, choline tartarate, choline itaconate, other choline di, tri and polycarboxylate counterion salts, choline trichloroacetate, choline trifluoroacetate, other choline halogenated carboxylate counterion salts, or mixture or combinations thereof. Other choline carboxylate counterion salts useful in the drilling fluids of this invention include choline amino acid counterion salts including choline salts of all naturally occurring and synthetic amino acids such as alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, (R)-Boc-4-(4-pyridyl)-β-Homoala-OH purum, (S)-Boc-4-(4-pyridyl)-β-Homoala-OH purum, (R)-Boc-4-trifluoromethyl-β-Homophe-OH purum, (S)-Fmoc-3-trifluoromethyl-β-Homophe-OH purum, (S)-Boc-3-trifluoromethyl-β-Homophe-OH purum, (S)-Boc-2-trifluoromethyl-β-Homophe-OH purum, (S)-Fmoc-4-chloro-β-Homophe-OH purum, (S)-Boc-4-methyl-β-Homophe-OH purum, 4-(Trifluoromethyl)-L-phenylalanine purum, 2-(Trifluoromethyl)-D-phenylalanine purum, 4-(Trifluoromethyl)-D-phenylalanine purum, 3-(2-Pyridyl)-L-alanine purum, 3-(2-Pyridyl)-L-alanine purum, 3-(3-Pyridyl)-L-alanine purum, or mixtures or combinations thereof or mixtures or combinations of these amino acid choline salts with other choline salts. Other preferred carboxylate counterions are counterions formed from a reaction of a carboxylic acid or carboxylate salt with an alkenyl oxide to form a carboxylate polyalkylene oxide alkoxide counterion salt. Preferred alkenyl oxides include ethylene oxide, propylene oxide, butylene oxide, and mixtures and/or combinations thereof.

Exemplary examples of choline nitrogen oxide counterion salts including choline nitrate, choline nitrite, choline NₓO_{y} counterion salts or mixtures or combinations thereof.

Exemplary examples of choline phosphorus oxide counterion salts include choline phosphate, choline phosphite, choline hydrogen phosphate, choline dihydrogen phosphate, choline hydrogen phosphite, choline dihydrogen phosphite, or mixtures or combinations thereof.

Exemplary examples of choline sulfur oxide counterion salts include choline sulfate, choline hydrogen sulfate, choline persulfate, choline alkali metal sulfates, choline alkaline earth metal sulfates, choline sulfonate, choline alkylsulfonates, choline sulfamate (NH₂SO₃⁻), choline taurinate (NH₂CH₂CH₂SO₃⁻), or mixtures or combinations thereof.

Exemplary examples of choline halogen oxide counterion salts including choline chlorate, choline bromate, choline iodate, choline perchlorate, choline perbromate, choline periodate, or mixtures or combinations thereof.

Exemplary examples of choline metal oxide counterion salts including choline dichromate, choline iron citrate, choline iron oxalate, choline iron sulfate, choline tetrathiocyanatodiamminechromate, choline tetrathiomolybdate, or mixtures or combinations thereof.

Exemplary examples of choline carbon oxide counterion salts include choline carbonate, choline bicarbonate, choline alkali carbonates, choline alkaline earth metal carbonates, or mixtures or combinations thereof.

Exemplary examples of choline boron oxide counterion salts including choline borate, tetraphenyl borate, or mixtures or combinations thereof.

Exemplary examples of choline perfluoro counterion salts including choline tetrafluoroborate, choline hexafluoroantimonate, choline heptafluorotantalate(V), choline hexafluorogermanate(IV), choline hexafluorophsophate, choline hexafluorosilicate, choline hexafluorotitanate, choline metavanadate, choline metatungstate, choline molybdate, choline phosphomolybdate, choline trifluoroacetate, choline trifluoromethanesulfonate, or mixtures or combinations thereof.

Exemplary examples of choline hydrogen oxide counterion salts including choline hydroxide, choline peroxide, choline superoxide, mixtures or combinations thereof. hydroxide reacted with: formic acid; acetic acid; phosphoric acid; hydroxy acetic acid; nitric acid; nitrous acid; poly phos; derivatives of P₂O₅; acid;(acid of glyoxal); sulfuric; all the amino acids (lycine, torine, glycine, etc.); NH₂CH₂CH₂SO₃H; sulfamic; idodic; all the fatty acids; diamethylol proprionic acid; cyclolaucine; phosphorous; boric; proline; benzoic acid; tertiary chloro acetic; fumeric; salicylic; choline derivatives; ethylene oxide; propylene oxide; butylene oxide; epilene chloro hydrine; ethylene chloro hydrine; choline carbonate; and choline peroxide.

One preferred class of choline salts of this invention is given by the general formula (I):

HOCH₂CH₂N⁺(CH₃)₃.R¹COO⁻ (I)

where R¹ is an alkyl group, alkenyl group, alkynyl group, an aryl group, an alkaryl group, an aralkyl group, alkenylaryl group, aralkenyl group, alkynylaryl group, aralkynyl group hetero atom analogs, where the hetero atom is selected from the group consisting of boron, nitrogen, oxygen, fluorine, phosphorus, sulfur, chlorine, bromine, iodine, and mixture or combinations thereof, or mixtures or combinations thereof.

While choline halides have been used in drilling, completion and production operations under over-balanced conditions, choline carboxylate salts have not been used in such applications. These new anti-swell additives should enjoy broad utility in all conventional drilling, completion and/or production fluids.

### pH Modifiers

Suitable pH modifiers for use in this invention include, without limitation, alkali hydroxides, alkali carbonates, alkali bicarbonates, alkaline earth metal hydroxides, alkaline earth metal carbonates, alkaline earth metal bicarbonates and mixtures or combinations thereof. Preferred pH modifiers include NaOH, KOH, Ca(OH)₂, CaO, Na₂CO₃, KHCO₃, K₂CO₃, NaHCO₃, MgO, Mg(OH)₂ and combination thereof.

### Weight Reducing Agents and Foamers

The weight reducing agents and foamers use for this invention include, without limitation, any weight reducing agent or foamer currently available or that will be come available during the life time of this patent application or patent maturing therefrom. Preferred foamers are those available from Weatherford International, Inc. facility in Elmendorf, Tex. Generally, the foamers used in this invention can include alone or in any combination an anionic surfactant, a cationic surfactant, a non-ionic surfactant and a zwitterionic surfactant. Preferred foaming agents includes those disclosed in co-pending U.S. patent application Ser. No. 10/839,734 filed May 5, 2004.

### Other Corrosion Inhibitors

Suitable corrosion inhibitor for use in this invention include, without limitation: quaternary ammonium salts e.g., chloride, bromides, iodides, dimethylsulfates, diethylsulfates, nitrites, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C₆ to C₂₄ synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Other Additives

The drilling fluids of this invention can also include other additives as well such as scale inhibitors, carbon dioxide control additives, paraffin control additives, oxygen control additives, or other additives.

### Scale Control

Suitable additives for Scale Control and useful in the compositions of this invention include, without limitation: Chelating agents, e.g., Na, K or NH₄⁺ salts of EDTA; Na, K or NH₄⁺ salts of NTA; Na, K or NH₄⁺ salts of Erythorbic acid; Na, K or NH₄⁺ salts of thioglycolic acid (TGA); Na, K or NH₄⁺ salts of Hydroxy acetic acid; Na, K or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexametaphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C₁₀ to C₂₄ amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids and/or N-methyl-2-pyrrolidone is oil solubility is desired.

### Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to produce sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Weighting Agents

The fluids of this invention may also include a weighting agent including, without limitation, barite, ferrosilicon, calcium carbonate, hematite, other materials that increase a density or weight of the fluid, or mixtures or combinations thereof.

### Fracturing Fluids

Generally, a hydraulic fracturing treatment involves pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. After fracturing the formation, a propping agent, generally a solid material such as sand is added to the fluid to form a slurry that is pumped into the newly formed fractures and/or enlarged fractures in the formation to prevent them from closing when the pumping pressure is released. The proppant transport ability of a base fluid depends on the type of viscosifying additives added to the water base. Alternatively, the proppant can be present in the fracturing fluid from the outset.

Water-base fracturing fluids with water-soluble polymers added to make a viscosified solution are widely used in the art of fracturing. Since the late 1950s, more than half of the fracturing treatments are conducted with fluids comprising guar gums, high-molecular weight polysaccharides composed of mannose and galactose sugars, or guar derivatives such as hydropropyl guar (HPG), carboxymethyl guar (CMG). carboxymethylhydropropyl guar (CMHPG). Crosslinking agents based on boron, titanium, zirconium or aluminum complexes are typically used to increase the effective molecular weight of the polymer and make them better suited for use in high-temperature wells.

The proppant type can be sand, intermediate strength ceramic proppants (available from Carbo Ceramics, Norton Proppants, etc.), sintered bauxites and other materials known to the industry. Any of these base propping agents can further be coated with a resin (available from Santrol, a Division of Fairmount Industries, Borden Chemical, etc.) to potentially improve the clustering ability of the proppant. In addition, the proppant can be coated with resin or a proppant flowback control agent such as fibers for instance can be simultaneously pumped. By selecting proppants having a contrast in one of such properties such as density, size and concentrations, different settling rates will be achieved.

In order for the treatment to be successful, it is preferred that the fluid viscosity eventually diminish to levels approaching that of water after the proppant is placed. This allows a portion of the treating fluid to be recovered without producing excessive amounts of proppant after the well is opened and returned to production. The recovery of the fracturing fluid is accomplished by reducing the viscosity of the fluid to a lower value such that it flows naturally from the formation under the influence of formation fluids. This viscosity reduction or conversion is referred to as “breaking” and can be accomplished by incorporating chemical agents, referred to as “breakers,” into the initial gel.

In addition to the importance of providing a breaking mechanism for the gelled fluid to facilitate recovery of the fluid and to resume production, the timing of the break is also of great importance. Gels which break prematurely can cause suspended proppant material to settle out of the gel before being introduced a sufficient distance into the produced fracture. Premature breaking can also lead to a premature reduction in the fluid viscosity, resulting in a less than desirable fracture width in the formation causing excessive injection pressures and premature termination of the treatment.

Suitable solvents fore use in this invention include, without limitation, water. The solvent may be an aqueous potassium chloride solution.

Suitable inorganic breaking agents include, without limitation, a metal-based oxidizing agent, such as an alkaline earth metal or a transition metal; magnesium peroxide, calcium peroxide, or zinc peroxide.

Suitable ester compounds include, without limitation, an ester of a polycarboxylic acid, e.g., an ester of oxalate, citrate, or ethylene diamine tetraacetate. Ester compound having hydroxyl groups can also be acetylated, e.g., acetylated citric acid to form acetyl triethyl citrate.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including boron, zirconium, and titanium containing compounds, or mixtures thereof. One class of suitable crosslinking agents is organotitanates. Another class of suitable crosslinking agents is borates as described, for example, in U.S. Pat. No. 4,514,309. The selection of an appropriate crosslinking agent depends upon the type of treatment to be performed and the hydratable polymer to be used. The amount of the crosslinking agent used also depends upon the well conditions and the type of treatment to be effected, but is generally in the range of from about 10 ppm to about 1000 ppm of metal ion of the crosslinking agent in the hydratable polymer fluid. In some applications, the aqueous polymer solution is crosslinked immediately upon addition of the crosslinking agent to form a highly viscous gel. In other applications, the reaction of the crosslinking agent can be retarded so that viscous gel formation does not occur until the desired time.

It should be understood that the above-described method is only one way to carry out embodiments of the invention. The following U.S. patents disclose various techniques for conducting hydraulic fracturing which may be employed in embodiments of the invention with or without modifications: U.S. Pat. Nos. 6,793,018; 6,756,345; 6,169,058; 6,135,205; 6,123,394; 6,016,871; 5,755,286; 5,722,490; 5,711,396; 5,551,516; 5,497,831; 5,488,083; 5,482,116; 5,472,049; 5,411,091; 5,402,846; 5,392,195; 5,363,919; 5,228,510; 5,224,546; 5,074,359; 5,024,276; 5,005,645; 4,938,286; 4,926,940; 4,892,147; 4,869,322; 4,852,650; 4,848,468; 4,846,277; 4,830,106; 4,817,717; 4,779,680; 4,479,041; 4,739,834; 4,724,905; 4,718,490; 4,714,115; 4,705,113; 4,660,643; 4,657,081; 4,623,021; 4,549,608; 4,541,935; 4,378,845; 4,067,389; 4,007,792; 3,965,982; 3,960,736; and 3,933,205, (incorporated herein by reference by action of the last paragraph of the disclosure prior to the claims).

### EXPERIMENTS OF THE INVENTION

### General

Each of the formulations presented below were prepared with a MULTIMIXER (available from Hamilton Beach Corp) by mixing over stated duration followed by evaluation of the formulations flow and other relevant physical properties at 120° F. Following measurement of initial properties, the formulations were transferred to aging cells and pressurized to 100 psi with nitrogen (usually membrane nitrogen—96% nitrogen, 4% oxygen) and then dynamically aged at specified temperatures for 16 h in roller oven. After aging, the formulations were cooled to room temperature, mixed on the MULTIMIXER for 5 minutes at low speed and pH adjusted to a desired specification prior to rheology measurement. All flow properties (initial and final) were recorded at 120° F. Dial readings were recorded with Ofite Model 900 viscometer.

### Example 1

This example illustrate the preparation and testing of a phosphate brine (PB) of this invention viscosified with a xanthan gum XANVIS®, a registered trademark of CP Kelco ApS and/or CP Kelco U.S., Inc.

To 350 mL of a PB having a density of 14.22 ppg were added 0.5 g of XANVIS®. The resulting mixture was stirred for 30 minutes. This procedure was used to produce two samples designated 1A and 1B.

The two samples, 1A and 1B, were tested at 450° F. and the results are tabulated in Table I. Surprisingly, the bio-polymer did not degrade as would be expected at 450° F. Although, thermal stability of xanthan gums is known to be extended by brine (e.g., CaBr₂ and formates; see U.S. Pat. No. 5,804,535 and US 2006/0178273 A1), stability to a temperature of 450° F. is unprecedented and to our knowledge has never been disclosed or observed before.

TABLE I
Viscosity Testing of Sample 1A and 1B

| | 1A | | | | |
|---|---|---|---|---|---|
| Est. at 120° F. | initial | 1B initial | Est. at 120° F. | 1A final | 1B final |
| 6 RPM | 66.7 | 67.2 | 6 RPM | 74.1 | 75.4 |
| 600 RPM | | | 600 RPM | | |
| 3 RPM | 34.1 | 34.6 | 3 RPM | 40.1 | 40.5 |
| 300 RPM | | | 300 RPM | | |
| 200 RPM | 23 | 23 | 200 RPM | 27 | 27.2 |
| 100 RPM | 11.3 | 11.5 | 100 RPM | 13.7 | 13.7 |
| 6 RPM | 0.6 | 0.7 | 6 RPM | 0.7 | 0.8 |
| 3 RPM | 0.4 | 0.5 | 3 RPM | 0.6 | 0.5 |
| Vp | 32.6 | 32.6 | Vp | 34 | 34.9 |
| YP | 1.5 | 2 | YP | 6.1 | 5.6 |
| Va | 33.35 | 33.6 | Va | 37.05 | 37.7 |
| 10 second gel | 0.4 | 0.4 | 10 second gel | 0.5 | 0.3 |
| 10 minute gel | 0.3 | 0.3 | 10 minute gel | 0.4 | 0.3 |
| pH | 11.2 | 10.9 | pH | 10.5 | 10.9 |

Va is apparent viscosity (cP), calculated as (Θ600 rpm)/2
Vp is plastic viscosity (cP), calculated as Θ600 rpm − Θ300 rpm
YP is yield point (lb/100 ft²) calculated as 2(Θ300 rpm) − Θ600 rpm.

### Example 2

This example illustrate the preparation and testing of a phosphate brine (PB) of this invention viscosified by DPR 5165 (Partially hydrolyzed acrylamide-AMPS co-polymer from SNF Inc., Riceboro Ga. USA) and xanthan gum XANVIS®, a registered trademark of CP Kelco ApS and/or CP Kelco U.S., Inc.

To 350 mL of a PB having a density of 14.22 ppg were added 1 g of DPR 5165 and 0.25 g of XANVIS ®. The resulting mixture was stirred for 30 minutes. This procedure was used to produce two samples designated 2A and 2B.

Physical and flow properties of the two samples, 2A and 2B, were tested at 120° F., after aging at 250° F. and 450° F., respectively. The viscosity results are tabulated in Table II.

TABLE II
Viscosity Testing of Sample 2A and 2B

| | | | AHR* at | AHR at |
|---|---|---|---|---|
| Est. at 120° F. | 2A initial | 2B initial | 250° F. 2A | 450° F. 2B |
| 6 RPM 600 RPM | 78.4 | 78.1 | 80.4 | 80.7 |
| 3 RPM 300 RPM | 40.3 | 39.9 | 41.8 | 41.8 |
| 200 RPM | 27.4 | 27 | 28 | 27.9 |
| 100 RPM | 13.7 | 13.5 | 13.8 | 14.3 |
| 6 RPM | 0.8 | 0.9 | 1.1 | 1.4 |
| 3 RPM | 0.8 | 0.6 | 1.1 | 1.4 |
| Vp | 38.1 | 38.2 | 38.6 | 38.9 |
| YP | 2.2 | 1.7 | 3.2 | 2.9 |
| Va | 39.2 | 39.05 | 40.2 | 40.35 |
| 10 second gel | 0.2 | 0.5 | 0.8 | 1.1 |
| 10 minute gel | 0.2 | 0.4 | 0.8 | 1 |
| pH | 11.4 | 11.1 | 10.6 | 10.9 |

*AHR is after hot rolling at specified temperature.
Va is apparent viscosity (cP), calculated as (Θ600 rpm)/2
Vp is plastic viscosity (cP), calculated as Θ600 rpm − Θ300 rpm
YP is yield point (lb/100 ft²) calculated as 2(Θ300 rpm) − Θ600 rpm.

Again, the viscosified phosphate brines show surprising and unprecedented stability at temperature up to 450 ° F. Although, higher temperatures were not investigated, the inventors believe that the viscositfied phosphate brines should be stable even up to temperature of 600° F. due to the stability of the brines at 250° F. and 450° F.

### Example 3

This example illustrate the preparation and testing of a phosphate brine (PB) of this invention viscosified by DPR 5165 (Partially hydrolyzed acrylamide-AMPS co-polymer from SNF Inc., Riceboro Ga. USA).

To 350 mL of PB having a density of 14.22 ppg were added 6.68 g of DPR 5165 and stirred for 30 minutes to form sample designated 3A. To 350 mL of PB having a density of 14.22 ppg were added 3.34 g of DPR 5165 and stirred for 30 minutes to form sample designated 3B.

Physical and flow properties of the two samples, 3A and 3B, were tested at 450° F. and the results are tabulated in Table III.

TABLE III
Viscosity Testing of Sample 3A and 3B

| Est. A 120° F. | 3A initial | 3B initial | 3A final | 3B final |
|---|---|---|---|---|
| 6 RPM 600 RPM | 66.3 | 66 | 76.8 | 72 |
| 3 RPM 300 RPM | 33.4 | 34 | 39 | 36 |
| 200 RPM | 22.3 | 23 | 25 | 24 |
| 100 RPM | 11.2 | 11 | 13 | 12 |
| 6 RPM | 1.1 | 1 | 0.5 | 2 |
| 3 RPM | 1.1 | 1 | 0 | 1 |
| Vp | 32.9 | 32 | 389 | 35 |
| YP | 0.5 | 2 | 1 | 0 |
| Va | 33.15 | 33 | 38 | 36 |
| 10 second gel | 0 | 0 | 0 | 1 |
| 10 minute gel | 0 | 0 | 0 | 1 |
| pH | 10.5 | 11.5 | 10.5 | 10.7 |

Va is apparent viscosity (cP), calculated as (Θ600 rpm)/2
Vp is plastic viscosity (cP), calculated as Θ600 rpm − Θ300 rpm
YP is yield point (lb/100 ft²) calculated as 2(Θ300 rpm) − Θ600 rpm.

Samples 3A and 3B still had some polymer that did not hydrate completely. Sample 3A more so than sample 1. Therefore no data collected prior to hot rolling. Heat aging of samples 3A and 3B allowed hydration to occur, some polymer still visible on top of sample. Sample 3B was too viscous to mix and therefore untestable. Again, the viscosified phosphate brines show surprising and unprecedented stability at temperature up to 450° F. Although, higher temperatures were not investigated, the inventors believe that the viscositfied phosphate brines should be stable even up to temperature of 600° F. due to the stability of the brines at 250° F. and 450° F.

### Example 4

This example illustrate the preparation and testing of a phosphate brine (PB) of this invention viscosified by xanthan gums DPR 5165.

To 350 mL of PB having a density of 13 ppg were added in the following order 0.75 g of xanvix®, 2.0 g starch (Aquabloc HT, from Aquasol USA), 15.0 g CaCO₃ (medium, from Weatherford Int.) and WEL-PAC LV (4.0 g, polyanionic cellulose, from Weatherford Int.). Resultant mixture following each additive addition in the order presented was mixed for 3 min and continued for a total of 30 minutes to form sample designated 4A. The same order of addition and mixing time were maintained for 4B except that 2.0 g of xanvis® and 1.0 g of the starch were used in place of the amounts stated for 4A.

Physical and flow properties of the two samples, 4A and 4B, were tested at 120° F. and 450° F. and the results are tabulated in Table IV.

TABLE IV
Viscosity Testing of Sample 4A and 4B

| | | | AHR* at | AHR at |
|---|---|---|---|---|
| Est. at 120° F. | 4A initial | 4B initial | 250° F. 4A | 250° F. 4B |
| 6 RPM 600 RPM | 27 | 28 | 44 | 85 |
| 3 RPM 300 RPM | 14 | 24 | 23 | 52 |
| 200 RPM | 10 | 15 | 16 | 41 |
| 100 RPM | 5 | 10 | 9 | 26 |
| 6 RPM | 1 | 0 | 1 | 5 |
| 3 RPM | 1 | 0 | 1 | 3 |
| Vp | 38.1 | 4 | 21 | 33 |
| YP | 2.2 | 20 | 2 | 19 |
| Va | 14 | 14 | 22 | 43 |
| 10 second gel | 1 | 0.5 | 1 | 3 |
| 10 minute gel | 3 | 0.4 | 3 | 3 |
| pH | 8 | 8 | 8 | 8 |

*AHR is after hot rolling at specified temperature.
Va is apparent viscosity (cP), calculated as (Θ600 rpm)/2
Vp is plastic viscosity (cP), calculated as Θ600 rpm − Θ300 rpm
YP is yield point (lb/100 ft²) calculated as 2(Θ300 rpm) − Θ600 rpm.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A composition for use in downhole operations comprising:
a phosphate brine having a density of greater than 10 pounds per gallon (ppg) and an effective amount of a viscosifying system including a hydratable polymer, where the effective amount is sufficient to produce a visocosified phosphate brine having a viscosity of at least 5 cP and where the brine is stable of temperatures up to 450° F.

2. The composition of claim 1, wherein the density is greater than or equal to 12 ppg.

3. The composition of claim 1, wherein the density is greater than or equal to 13 ppg.

4. The composition of claim 1, wherein the brine is stable of temperatures up to 500° F.

5. The composition of claim 1, wherein the brine is stable of temperatures up to 600° F.

6. The composition of claim 1, wherein the viscosity between about 5 cP and about 600 cP.

7. The composition of claim 1, wherein the viscosity between about 5 cP and about 500 cP.

8. The composition of claim 1, wherein viscosity between about 10 cP and about 100 cP.

9. A method for completing or working over of a well comprising:
completing or reworking the well in the presence of a completion fluid composition including a phosphate brine having a density of greater than 10 pounds per gallon (ppg) and an effective amount of a viscosifying system including a hydratable polymer, where the effective amount is sufficient to produce a visocosified phosphate brine having a viscosity of at least 5 cP and where the brine is stable of temperatures up to 450° F.

10. The method of claim 9, wherein the density is greater than or equal to 12 ppg.

11. The method of claim 9, wherein the density is greater than or equal to 13 ppg.

12. The method of claim 9, wherein the brine is stable of temperatures up to 500° F.

13. The method of claim 9, wherein the brine is stable of temperatures up to 600° F.

14. The method of claim 9, wherein the viscosity between about 5 cP and about 600 cP.

15. The method of claim 9, wherein the viscosity between about 5 cP and about 500 cP.

16. The method of claim 9, wherein viscosity between about 10 cP and about 100 cP.

17. A method for drilling a well comprising:
circulated a drilling composition including a phosphate brine, while drilling, where the composition has a density of greater than 10 pounds per gallon (ppg) and an effective amount of a viscosifying system including a hydratable polymer, where the effective amount is sufficient to produce a visocosified phosphate brine having a viscosity of at least 5 cP and where brine is stable of temperatures up to 450° F.

18. The method of claim 17, wherein the density is greater than or equal to 12 ppg.

19. The method of claim 17, wherein the density is greater than or equal to 13 ppg.

20. The method of claim 17, wherein the brine is stable of temperatures up to 500° F.

21. The method of claim 17, wherein the brine is stable of temperatures up to 600° F.

22. The method of claim 17, wherein the viscosity between about 5 cP and about 600 cP.

23. The method of claim 17, wherein the viscosity between about 5 cP and about 500 cP.

24. The method of claim 17, wherein viscosity between about 10 cP and about 100 cP.
